(19) United States
(12) Patent Application Publication
(10) Pub. No.: US 2012/0086355 A1
(43) Pub. Date: Apr. 12, 2012

(54) CIRCUIT AND METHOD FOR DRIVING A LAMP

(75) Inventor: Juergen Klier, Traunreut (DE)

(73) Assignee: OSRAM AG, Muenchen (DE)

(21) Appl. No.: 13/253,165

(22) Filed: Oct. 5, 2011

(30) Foreign Application Priority Data
Oct. 6, 2010 (DE) 102010042020.4

(51) Int. Cl. H05B 37/02

(52) U.S. Cl. 315/291

(57) ABSTRACT

In various embodiments, a circuit for driving a lamp, which is operated via a bridge circuit, is provided. The circuit may include an analog controller configured to drive the bridge circuit in a first operating mode; and a logic circuit configured to drive the bridge circuit in a second operating mode.

### CROSS-REFERENCE TO RELATED APPLICATION

This application claims priority to German Patent Application Serial No. 10 2010 042 020.4, which was filed Oct. 6, 2010, and is incorporated herein by reference in its entirety.

### TECHNICAL FIELD

Various embodiments relate to a circuit and a method for driving a lamp, e.g. a fluorescent lamp. Furthermore, a lamp, light fixture or luminous module having at least one such circuit is proposed.

### BACKGROUND

In an electronic operating device for a lamp, also called electronic ballast, e.g. a dimmable model, two operating modes can be distinguished. On the one hand, there is a normal mode in which the lamp is burning and all operating parameters are within a permissible range. An operating frequency of a bridge circuit of the electronic operating device is determined by a lamp controller, a power controller or a current controller. On the other hand, there is also a fault mode in which the lamp is either not alight (e.g. during the preheating of the lamp or during the igniting of the lamp) or in which the lamp is alight but an overvoltage or an overcurrent is detected. In these cases, the operating frequency of the bridge circuit is determined by a circuit (e.g. a fault logic) responsible for the fault mode.

FIG. 1 shows a block diagram including an operating device for driving a lamp 101.

A fault signal 107 is detected by the input of a logic circuit 104, the output of the logic circuit controls a current source 105 which can provide a current I_{F} (fault current) at a node 108. The node 108 is connected to the input of a voltage-controlled oscillator (VCO) 103, the outputs of which drive a half-bridge circuit including MOSFETs Q1 and Q2, e.g. the gate terminals of the MOSFETs Q1, Q2. The drain terminal of MOSFET Q2 is connected to the source terminal of MOSFET Q1 and via an inductance L1 to a node 109. The drain terminal of MOSFET Q1 is connected to a supply voltage V_{bus} of the half-bridge circuit and the source terminal of MOSFET Q2 is connected to ground via a resistor R4.

Furthermore, the source terminal of MOSFET Q2 is also connected via a resistor R1 to the non-inverting input of an operational amplifier 102 which is also connected to ground via a capacitor C1. At the inverting input of the operational amplifier 102, a setpoint value 106 is present. Furthermore, the inverting input is connected to the node 108 via a capacitor C3. The output of the operational amplifier 102 is connected via a diode D1 to the node 108, the cathode of the diode D1 pointing in the direction of node 108. The node 108 is connected to ground via a resistor R2. The node 108 is also connected to ground via a capacitor C2.

The lamp 101 is connected, on the one hand, to the node 109 and, on the other hand, to ground via a capacitor C5. Between the node 109 and ground, a capacitor C4 is arranged.

In normal mode, the operational amplifier 102 performs a nominal/actual comparison between the predetermined value 106 (setpoint value) and a voltage across the resistor R4 (actual value), filtered by the RC element including resistor R1 and capacitor C1. The operational amplifier 102 controls the voltage-controlled oscillator 103 via the diode D1 and determines thus the respective appropriate operating frequency of the half-bridge circuit including MOSFETs Q1 and Q2. The half-bridge circuit supplies the lamp 101 with the required power via the inductance L1 and the capacitors C4 and C5.

In the case of a fault (which can also be a preheating phase or an igniting operation), the logic circuit 104 receives the fault signal 107 and actuates the current source 105 which charges the capacitor C2 with the fault current I_{F}. The voltage across the node 108 thus rises, as does the operating frequency of the half-bridge circuit. The operational amplifier 102 attempts to counteract this but cannot lower the voltage across the voltage-controlled oscillator 103, and thus the operating frequency of the half-bridge circuit, due to the decoupling by the diode D1.

If the fault has died down, fault current I_{F} is no longer impressed into the node. Resistor R2 discharges capacitor C2 until the operating frequency corresponds to that specified by the operational amplifier 102. The operational amplifier 102 thus controls the operating frequency of the half-bridge circuit again.

This approach exhibits the disadvantage that the operational amplifier 102 can lower the operating frequency only as fast as this is possible due to the time constant of the RC element of resistor R2 and capacitor C2 (time constant τ=R2C2). This can influence the stability of the control system disadvantageously.

FIG. 2 shows a diagrammatic block diagram for a digital approach.

Instead of VCO 103, a frequency counter 201 is used in FIG. 2 in order to drive the half-bridge circuit including MOSFETs Q1, Q2. The half-bridge circuit and the lamp 101 connected to it, with circuit elements via the inductance L1, capacitors C4 and C5 and the resistor R4, correspond to the circuit shown in FIG. 1.

A fault signal 206 is connected to the input of a logic circuit 205. The logic circuit 205 has an output 208 which indicates the operating mode (normal mode or fault mode). Furthermore, the logic circuit 205 has an output 209 which specifies a frequency for driving the half-bridge circuit. Outputs 208 and 209 are connected to a switching unit 202.

A setpoint value 207 is forwarded via an analog/digital converter 204 to a digital processing unit 203 (PU, controller), the output of which is connected to the input of the frequency counter 201 via the switching unit 202.

The source terminal of MOSFET Q2 is connected to the input of an analog/digital converter 210 via a resistor R5. The input of the analog/digital converter 210 is connected to ground via a capacitor C6 and the output of the analog/digital converter 210 is connected to an input of the processing unit 203.

In normal mode, the digital processing unit 203 performs a nominal/actual comparison in which the setpoint value 207 is compared with an actual value. The actual value is a voltage across resistor R4 which is filtered by means of the RC element of resistor R5 and capacitor C6. The analog setpoint value 207 is converted into a digital value by means of the analog/digital converter 204 and the voltage value across the resistor R4 is converted into a digital value by means of the analog/digital converter 210. The processing unit 203 controls the frequency counter 201 and thus determines the respective appropriate operating frequency of the half bridge Q1, Q2 which, in turn, supplies the lamp 101 with the required power via the inductance L1 in conjunction with capacitors C4 and C5.

In the case of a fault (which can also be a preheating phase or an igniting operation), the logic circuit 205 receives the fault signal 206 and itself controls the frequency counter 201. This is achieved by the logic circuit 205 (via its output 208) driving the switching unit 202 in such a manner that the frequency provided at output 209 adjusts the frequency counter 201 directly.

If the fault has passed, the logic circuit 205 (by means of its output 208) hands over control of the frequency again to the digital processing unit 203.

In this arrangement, it is of disadvantage that the digital processing unit 203 is relatively slow and specifies computing cycles which provide for an updating of the frequency of the frequency counter 201 only relatively rarely (e.g. every 100 μs). This effect is also amplified due to the fact that the analog/digital converters 204 and 210 need a processing time (e.g. approx. 10 μs) for converting the analog signals. A resultant dead time of approx. 110 μs can impair the stability of the control system distinctly.

### SUMMARY

In various embodiments, a circuit for driving a lamp, which is operated via a bridge circuit, is provided. The circuit may include an analog controller configured to drive the bridge circuit in a first operating mode; and a logic circuit configured to drive the bridge circuit in a second operating mode.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a block diagram including an operating device for driving a lamp;

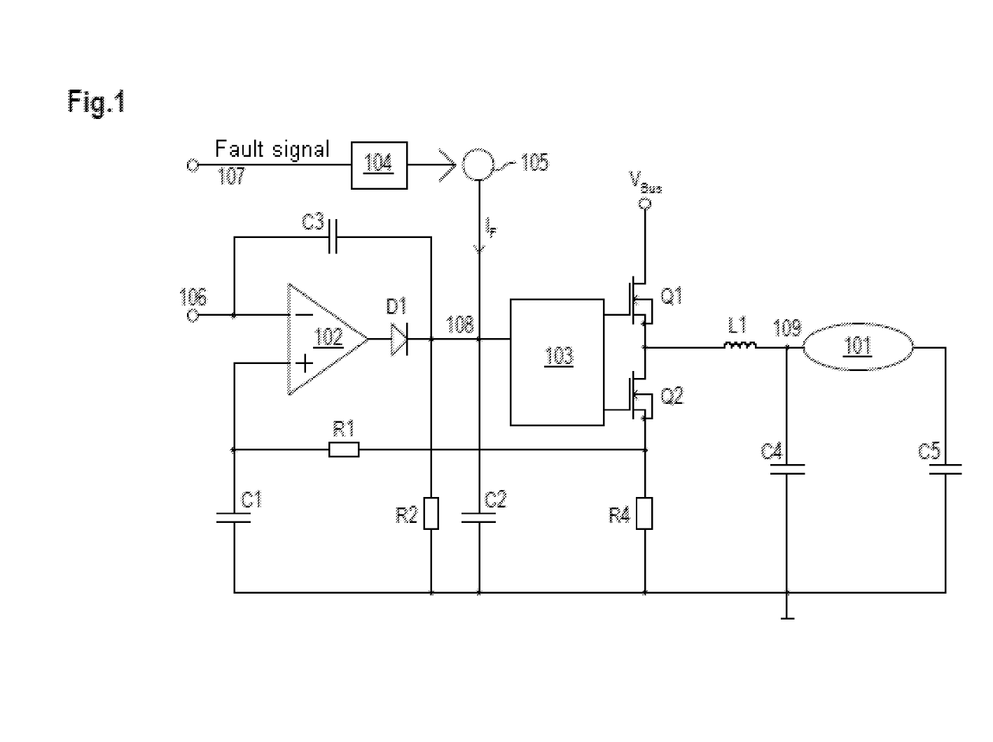

FIG. 2 shows a diagrammatic block diagram for a digital approach;

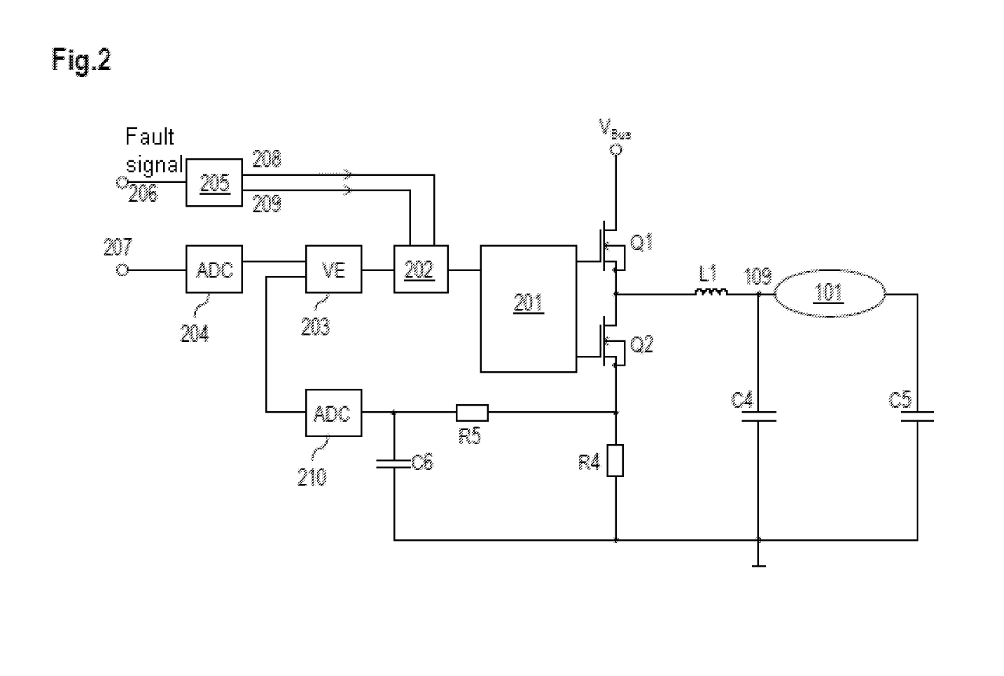

FIG. 3 shows a schematic block diagram with an electronic operating device including an analog controller and a logic circuit configured to drive a bridge circuit for operating a lamp, e.g. a fluorescent lamp;

FIG. 4 shows a diagram with an operating frequency for driving the half-bridge circuit when the lamp is glowing as a response to an overvoltage or an overcurrent;

FIG. 5, based on the circuit according to FIG. 3, shows a schematic block diagram with an electronic operating device for a lamp for preventing an ignition flash or for presetting the operational amplifier, respectively;

FIGS. 6A and 6B each show a diagram in which the operating frequency of the half-bridge circuit is represented over time;

FIG. 7 shows a schematic circuit diagram based on the circuits according to FIG. 3 or FIG. 5 including a temperature-dependent voltage limiter which is arranged between the operational amplifier and the analog/digital converter; and

FIG. 8 shows a diagram with an output voltage of the analog controller in dependence on the temperature.

### DETAILED DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments may avoid the aforementioned disadvantages and, for example, specify an efficient possibility for driving a lamp.

In various embodiments, a circuit for driving a lamp, e.g. a fluorescent lamp, is provided. The lamp is operated via a bridge circuit, e.g. a full- or half-bridge circuit. The circuit may include an analog controller (e.g. an analog control circuit) configured to drive the bridge circuit in a first operating mode and a logic circuit (e.g. a digital control circuit) configured to drive the bridge circuit in a second operating mode.

In this context, it is of advantage that the circuit exhibits only slight delays due to required signal conversion and thus the dead time of the analog controller in the first operating mode is small in comparison with a purely digital controller. As a result, a high degree of control stability is achieved. It may also be an advantage that the processing of the signals can be performed separately of one another in the two operating modes and that effective decoupling of the operating modes is thus achieved.

It is a development that the first operating mode is a normal mode in which the lamp is alight and, for example, neither too high an output voltage of the circuit nor too high a current occurs in the bridge circuit.

In the normal mode, the lamp may be operated (e.g. dimmed) and may glow correspondingly.

It is another development that the second operating mode is a fault mode including e.g. a preheating mode and/or an igniting mode in which the lamp, for example, is not alight.

In this context, the operating mode may include, e.g., all modes in which the lamp does not (yet) glow or all modes which do not correspond to the normal mode such as too high an output voltage or an overcurrent in the bridge circuit. In various embodiments, the igniting mode shortly before or during the igniting of the lamp is such a second operating mode. The preheating mode before the igniting of the lamp is also a second operating mode.

It is also a development that the fault mode may include a state in which the lamp is alight, wherein, in various embodiments, the circuit may exhibit an output voltage which is greater than a predetermined voltage threshold value and/or wherein a current which is greater than a predetermined current threshold value may flow in the bridge circuit.

The fault mode may thus also include the state of an overvoltage at the output of the circuit or an overcurrent in the bridge circuit.

In various embodiments, it is a development that the bridge circuit may exhibit a half-bridge circuit with two electronic switches, e.g. two transistors or two MOSFETs, the center tap of which is connected to the lamp via an inductance.

As an alternative, the bridge circuit may also include a full-bridge circuit.

It is also a development that the bridge circuit may be driven via a frequency counter, wherein the analog controller is connected to the frequency counter via an analog/digital converter in the first operating mode.

The analog controller thus provides in the first operating mode an analog signal which is converted into a digital signal via the analog/digital converter and is used for driving the frequency counter.

The frequency counter may be, for example, a unit (e.g. a circuit) configured to drive the bridge circuit, especially configured to drive electronic switches (e.g. MOSFETs or transistors) in a half- or a full-bridge circuit. For this purpose, the frequency counter may convert a digital input signal which corresponds to a frequency, for driving the bridge circuit. The higher the frequency, the faster the drive provided by the frequency counter for the electronic switch which will change.

An advantage thus may consist in that an operating frequency of the bridge circuit can be adjusted digitally by means of the frequency counter.

It is also a development that a switchover may be effected between the first operating mode and the second operating mode via a switching device which precedes the frequency counter and is connected to an output of the analog/digital converter and to an output of the logic circuit.

As part of an additional development, the logic circuit may initiate the switchover between the first operating mode and the second operating mode via a control signal, e.g. via a further output which is connected to the switching unit, e.g. one or more switches.

It is thus possible to achieve that the logic circuit, by means of the switching unit, controls the change between the first operating mode, in which the analog controller drives the bridge circuit, and the second operating mode, in which the logic circuit provides a frequency for driving the bridge circuit.

A next development may consist in that the switchover from the first operating mode into the second operating mode is effected if a fault signal is detected.

In various embodiments, a switchover between the first operating mode and the second operating mode may take place if the fault signal is detected.

The fault signal may indicate that this is not a normal operation of the lamp, i.e. that the lamp, e.g., does not glow or that it glows but the voltage dropped across it is too high or the current in the bridge circuit is too high. By means of (the detection of) the fault signal, the second operating mode may be started. In various embodiments, the fault signal may indicate that igniting or preheating of the lamp is required.

It is one embodiment that the analog controller may include an operational amplifier, the inverting input of which is connected to a setpoint value, the inverting input of which is connected via a capacitor to the output and at the non-inverting input of which an actual value of a lamp power or of a lamp current can be determined.

The setpoint value may be a dimming value, i.e. a value that corresponds to a brightness specification for adjusting the lamp. This value may be adjusted by a user, e.g. via a voltage divider or a voltage source including a controllable resistor.

An alternative embodiment may consist in that, during the second operating mode, as long as the lamp is not alight, the analog controller is set in such a manner that an output signal provided by it for driving the bridge circuit corresponds to a frequency which is between the operating frequency during the preheating and the operating frequency on igniting.

In other words, the analog controller may be preset even in the second operating mode, as long as the lamp is not alight and while it is not driving the bridge circuit, in such a manner that during a switchover to the first operating mode (that is to say when the drive is taken over by the analog controller) an ignition flash is prevented. In this arrangement, the analog controller may be adjusted, for example, in such a manner that its analog or digitized output signal corresponds to an operating frequency for the bridge circuit which is between the preheating frequency and the igniting frequency.

It is a next embodiment that the output signal of the analog controller may correspond to a mean value of the voltage for the current operating frequency f and a voltage for a preheating frequency fₘₐₓ.

In various embodiments, the output signal of the analog controller may be adjusted in such a manner that it corresponds to a drive of the half-bridge circuit with a frequency of a magnitude of f/2+fₘₐₓ/2, where f is the current operating frequency and fₘₐₓ is the preheating frequency.

A further embodiment may consist in that, during the second operating mode when the lamp glows but its voltage is too high or the current in the bridge circuit is too high, the logic circuit increases the operating frequency step by step. In this arrangement, the analog controller may take a control deviation and, in attempting to eliminate it, may specify a minimum operating frequency.

If no overvoltage or no overcurrent is detected, the logic circuit may reduce the frequency again step by step. As soon as the control deviation is minimum (equal to zero or less than a predetermined threshold value), the frequency specification of the analog controller jumps to the current operating frequency. The system thereupon switches back from the second operating mode to the first operating mode.

It is also an embodiment that a minimum operating frequency may be limited with rising temperature.

One development consists in that a temperature-dependent voltage limiter is provided by means of which a lower threshold value of a signal provided by the analog controller may be limited in dependence on the temperature.

In addition, a temperature-dependent voltage may be added (instead) to the output voltage of the analog controller (e.g. of the operational amplifier).

In various embodiments, a lamp, light fixture or luminous module including at least one of the circuits described here, are provided.

In various embodiments, a method for driving a lamp, for example a fluorescent lamp which is operated via a bridge circuit, is provided.
wherein the bridge circuit is driven via an analog controller in a first operating mode and
wherein the bridge circuit is driven via a logic circuit in a second operating mode.

The features of the circuit described above apply correspondingly to the method.

In various embodiments, a combination of an analog controller with a digital frequency generator configured to drive a bridge circuit configured to operate a (fluorescent) lamp is proposed.

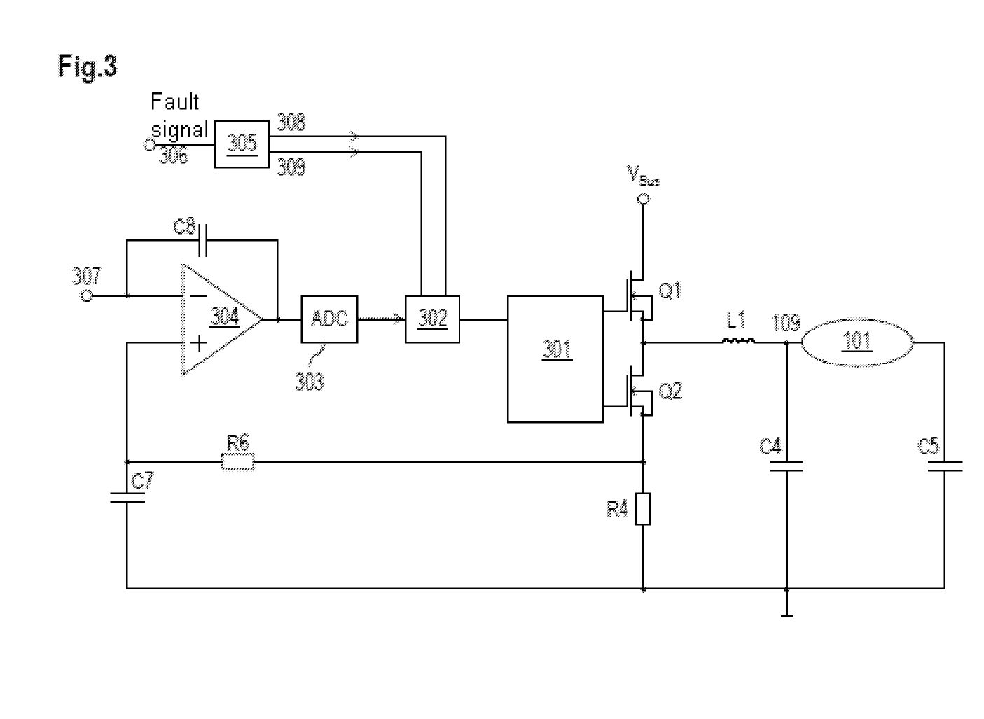

FIG. 3 shows a schematic block diagram with an electronic operating device for a lamp 101.

A fault signal 306 is connected to the input of a logic circuit 305. The logic circuit 305 has an output 308 which indicates the operating mode (normal mode or fault mode). Furthermore, the logic circuit 305 has an output 309 which specifies a frequency for driving a half-bridge circuit. Outputs 308 and 309 are connected to a switching unit 302.

A setpoint value 307 (e.g. a dimming value which can be adjusted by a user, i.e. a value for adjusting the brightness of the lamp) is conducted to an inverting input of an operational amplifier 304, the inverting input being connected to the output of the operational amplifier 304 via a capacitor C8. The output of the operational amplifier 304 is also connected to the switching unit 302 via an analog/digital converter 303. The switching unit 302 is connected at the output end to the input of the frequency counter 301.

The outputs of the frequency counter 301 are connected to the half-bridge circuit including Mosfets Q1 and Q2, e.g. to the gate terminals of Mosfets Q1, Q2. The drain terminal of Mosfet Q2 is connected to the source terminal of Mosfet Q1 and via an inductance L1 to a node 109. The drain terminal of Mosfet Q1 is connected to a supply voltage V_{bus} of the half-bridge circuit and the source terminal of Mosfet Q2 is connected to ground via a resistor R4.

The lamp 101 is connected, on the one hand, to node 109 and, on the other hand, to ground via a capacitor C5. Between the node 109 and ground, a capacitor C4 is arranged.

Furthermore, the source terminal of Mosfet Q2 is connected via a resistor R6 to the non-inverting input of the operational amplifier 304 which is connected to ground via a capacitor C7.

The lamp 101 may be, for example, a fluorescent lamp.

The (analog) operational amplifier 304 acts as an analog controller and performs a nominal/actual comparison of analog voltages: the (predetermined) setpoint value 307 is compared with the voltage which is dropped across resistor R4, this voltage being filtered by means of the RC element of resistor R6 and capacitor C7.

The output signal provided by the operational amplifier 304 is converted into a digital signal by means of the analog/digital converter 303 and used for controlling the frequency counter 301 in normal mode (in normal mode, the operational amplifier 304 is connected by the switching unit 302 to the frequency counter 301 via the analog/digital converter 303). The operational amplifier 304 thus determines the operating frequency of the half-bridge circuit including Mosfets Q1, Q2 which supplies the lamp 101 with the required power via the inductance L1 in conjunction with capacitors C4 and C5.

In this context, it may be of advantage that only the conversion time needed by the analog/digital converter 303 contributes to the dead time of the analog controller. The controller thus exhibits a high degree of control stability overall. A further advantage may consist in that the analog controller and the logic circuit are effectively decoupled from one another. It may be another advantage that the operating frequency of the frequency counter 301 may be adjusted digitally.

After the electronic operating device has been switched on, the lamp 101 does not yet glow initially. The logic circuit 305 drives the frequency counter 301 for a period of approx. 0.5 seconds in such a manner that it provides the relatively high preheating frequency for the lamp 101. In this arrangement, the voltage which is dropped across the lamp 101 is low and its electrodes are preheated. After this period, the logic circuit 305 lowers the frequency down to an igniting frequency. At the igniting frequency, the voltage required for igniting the lamp 101 is generated by a resonant peak of the LC element of the inductance L1 and the capacitor C4. As soon as the voltage exceeds the required value, the frequency is raised again. If no further overvoltage is detected, the frequency is lowered again. In this manner, the voltage can be adjusted to a required value until the lamp has ignited. The frequency control is now taken over by the operational amplifier 304, normal operation has been achieved.

If an overvoltage or an overcurrent is detected in normal operation, the logic circuit 305 receives the fault signal 306 and itself controls the frequency counter 301. This is achieved in that the logic circuit 305 drives the switching unit 302 (via its output 308) in such a manner that the frequency provided at the output 309 adjusts the frequency counter 301 directly.

In various embodiments, the logic circuit 305 may increase the frequency step by step. If the fault is no longer present, the logic circuit 305 may reduce the frequency step by step until the control deviation has disappeared and the operational amplifier 304 can take over frequency control again.

Raising and lowering the operating frequency may take place at different speeds in each case.

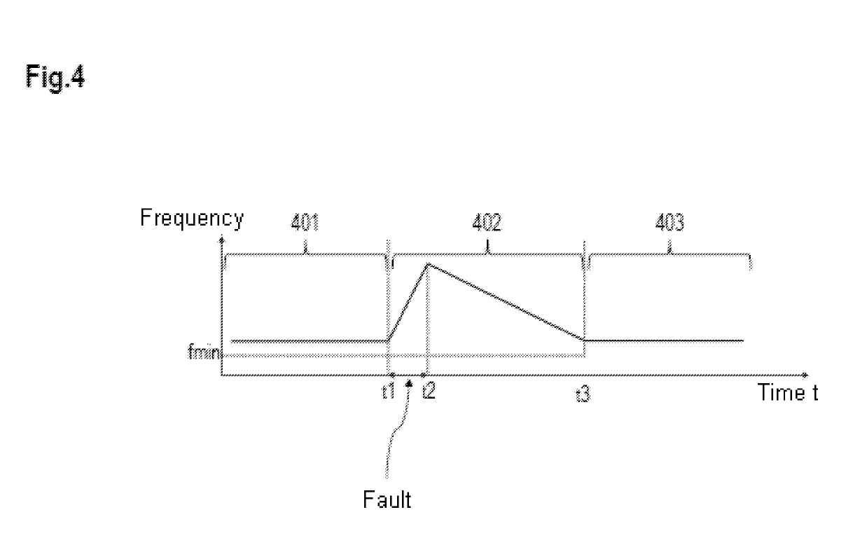

FIG. 4 contains a diagram which shows the operating frequency with which this half-bridge circuit is driven, for different modes of the controller. In a time interval 401, the operational amplifier 304 adjusts the operating frequency. This operating frequency is, for example, constant, this being the normal mode. At a time t1, a fault occurs. The logic circuit thereupon increases the operating frequency step by step until the fault disappears at a time t2 (FIG. 4 shows, for example, a stepless increase in the operating frequency). From time t2 onward, the logic circuit reduces the operating frequency, e.g. step by step (if the fault does not occur again) until a time t3 (shown symbolically in FIG. 4 as continuous decrease in the operating frequency). From time t3 onward, the steady-state value of the operating frequency is reached again and the operational amplifier 304 takes over frequency control. To this extent, the normal mode is reached again in a time interval 403.

The time interval 402 between times t1 and t3 may be called a fault mode. During this period of time, the logic circuit 305 specifies a higher frequency than is suitable for meeting the setpoint-value specification so that the operational amplifier 304 detects a control deviation and, in attempting to eliminate it, sets its output to 0V which corresponds to the minimum operating frequency fₘᵢₙ of the half-bridge circuit.

Embodiment: Preventing an Ignition Flash

In its effort to increase the lamp power by lowering the operating frequency to the setpoint value, the operational amplifier 304 keeps its output at 0V in igniting mode. When lamp 101 has ignited and the control of the operating frequency is handed over by means of the switching device 302 to the operational amplifier 304, the latter initially operates the lamp 101 at the lowest possible frequency, that is to say at the highest power. The power is reduced to the setpoint value only with delay due to the capacitor C8 arranged in the feedback. In this arrangement, an interfering ignition flash may be produced.

This ignition flash may be prevented as follows: the operating frequency in the lowest dimming position is approximately in the center between the preheating frequency and the ignition frequency. This also applies at higher temperatures at which the lamp 101 ignites already at lower voltage and correspondingly higher frequency.

As long as the lamp 101 is not yet alight, the output of the operational amplifier 304 is kept at a voltage which corresponds to the mean value of the voltage for the current operating frequency f and the voltage for the preheating frequency fₘₐₓ. After the ignition, the lamp 101 is operated initially in the lowest dimming position which effectively prevents the ignition flash.

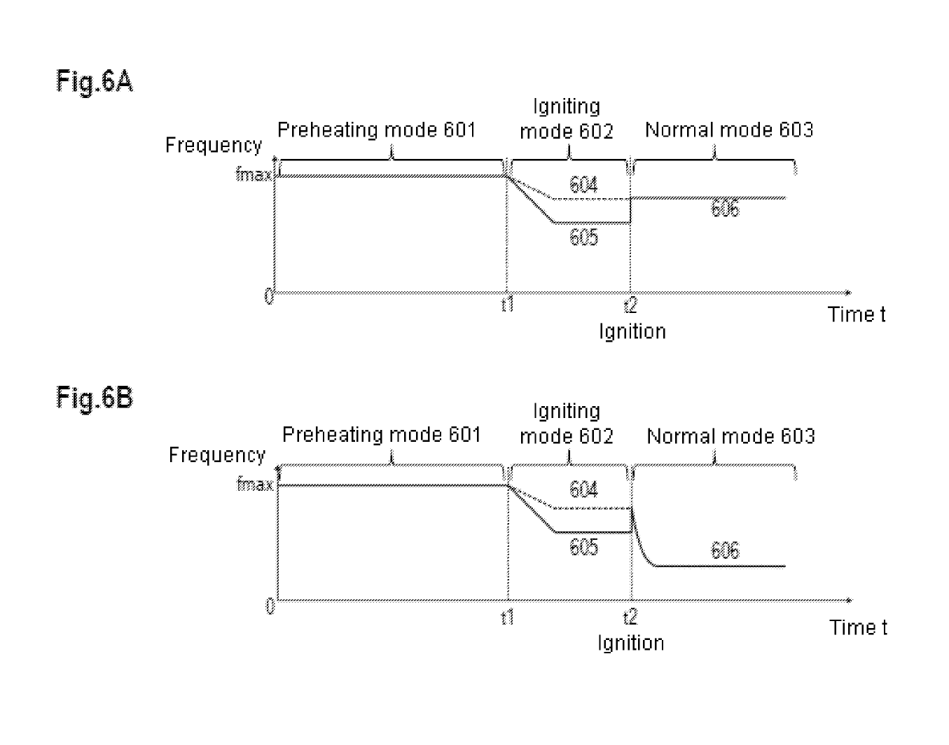

FIG. 6A and FIG. 6B each show a diagram in which the operating frequency of the half-bridge circuit is represented over time.

Up to a time t1, the lamp 101 is preheated (preheating mode 601), between times t1 and t2, the lamp 101 is ignited (igniting mode 602) and from time t2 onward, lamp 101 is operated in normal mode 603, in the lowest dimming position in FIG. 6A and with full power in FIG. 6B.

The operating frequency fₘₐₓ during the preheating mode 601 is provided by the logic circuit 305. During the igniting mode, the operating frequency 605 is provided by the logic circuit 305, the output of the operational amplifier 304 is then set to a voltage which corresponds to the operating frequency according to a variation 604. From time t2 in normal mode 603, the operational amplifier takes over the provision of the operating frequency (see variation 606) or the driving of the lamp 101, respectively. By presetting the output of the operational amplifier 304 to a voltage which corresponds to the mean value of the preheating frequency fₘₐₓ and the current operating frequency, an interfering ignition flash may be prevented.

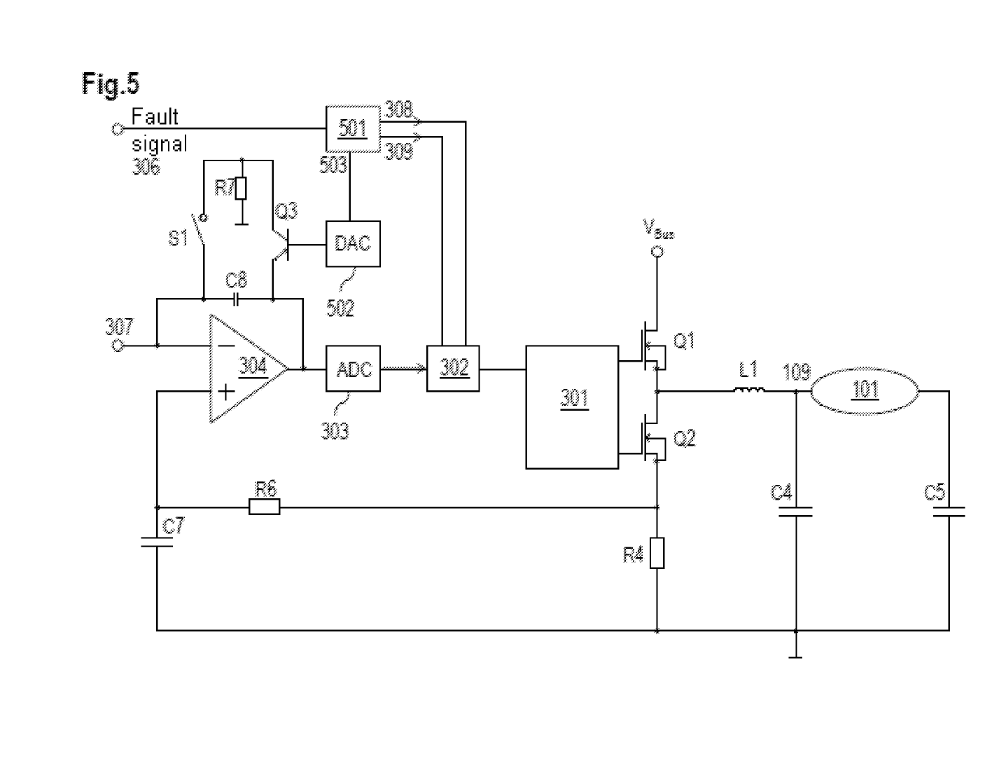

FIG. 5 shows, on the basis of the circuit according to FIG. 3, a schematic block diagram with an electronic operating device for the lamp 101 for preventing the ignition flash and for presetting the operational amplifier 304, respectively. In the text which follows, the differences between the circuit according to FIG. 5 and the circuit shown in FIG. 3 will be explained. Reference is made to the above statements with respect to the unchanged components.

The fault signal 306 is connected to the input of a logic circuit 501. Corresponding to the logic circuit 305 shown in FIG. 3, the logic circuit 501 has an output 308 which indicates the operating mode (normal mode or fault mode). Furthermore, the logic circuit 501 has an output 309 which specifies a frequency for driving the half-bridge circuit. Outputs 308 and 309 are connected to the switching unit 302.

The logic circuit 501 also has an output 503 which is connected to the base of a pnp transistor Q3 via a digital/analog converter 502. At the output 503, the logic circuit 501 provides a digital value for setting an operating frequency

f_{Q3}=f/2+fₘₐₓ/2,

where f designates the current operating frequency and fₘₐₓ designates the preheating frequency.

The emitter of transistor Q3 is connected to the output of the operational amplifier 304 and the collector of transistor Q3 is connected to the inverting input of the operational amplifier 304 via a switch S1. A resistor R7 is arranged between the collector of transistor Q3 and ground.

The output of the operational amplifier 304 may be adjusted to a required voltage value by transistor Q3 connected in its feedback and controlled correspondingly by the logic circuit 501.

The logic circuit 501 provides, at its output 503, the digital value of a voltage for adjusting the operating frequency to the frequency f_{Q3}. The digital value is converted by means of the analog/digital converter 502 into a corresponding analog voltage value which, minus a voltage of 0.5 V in order to take into account the base-emitter threshold of transistor Q3, controls transistor Q3. Resistor R7 loads the setpoint-value specification which, as a result, becomes smaller than the power converted during preheating or igniting.

This functionality is active only during the preheating and during the igniting and is switched to be inactive as soon as the lamp is alight (i.e. as soon as normal mode is reached). This is achieved by means of the switch S1 which is opened as soon as normal mode is reached. The switch S1 may be an electronic switch, e.g. a transistor or a Mosfet which, e.g., may be controlled by the drive logic 501.

Embodiment: Temperature Limitation

If the electronic operating device is used in a hot environment, especially a hot light fixture, it is of advantage to reduce the lamp power in order to relieve the components of the operating device thermally and to save energy since the efficiency of a fluorescent lamp decreases greatly at a high ambient temperature.

In such an operating mode with reduced power, the temperature of the lamp and of the operating device drops as a result of which the efficiency increases, in turn, so that the light emitted remains approximately equal.

In an operating mode with full power, the operating voltage of a fluorescent lamp decreases with increasing temperature. To provide the full power also with a rising temperature, the electronic operating device should accordingly reduce the operating frequency. As soon as the lowest possible operating frequency is reached, a predetermined reduction in power occurs.

The output voltage of the operational amplifier 304 may vary within a certain range, e.g. within a range of from 0 V to 3.3 V. The downstream analog/digital converter 303 processes input voltages within a range of from 0.5 V to 3.3 V. With an input voltage of 0.5 V or less, the analog/digital converter 303 sets the frequency counter 301 to the minimum operating frequency.

In various embodiments, a temperature-dependent voltage limiter may be arranged between the operational amplifier 304 and the analog/digital converter 303, the lowest output voltage of which limiter is less than or equal to 0.5 V below a predetermined temperature, e.g. 80° C., but is above 0.5 V above this temperature. The analog/digital converter 303 can thus no longer set the minimum operating frequency above the specified temperature and the maximum possible lamp power is lowered further.

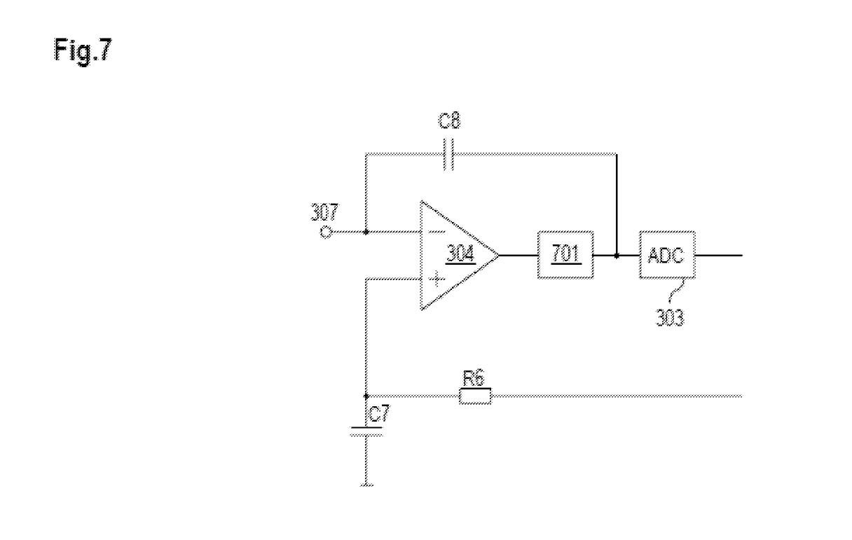

FIG. 7 shows a schematic circuit diagram based on the circuits according to FIG. 3 or FIG. 5 including a temperature-dependent voltage limiter 701 which is arranged between the operational amplifier 304 and the analog/digital converter 303.

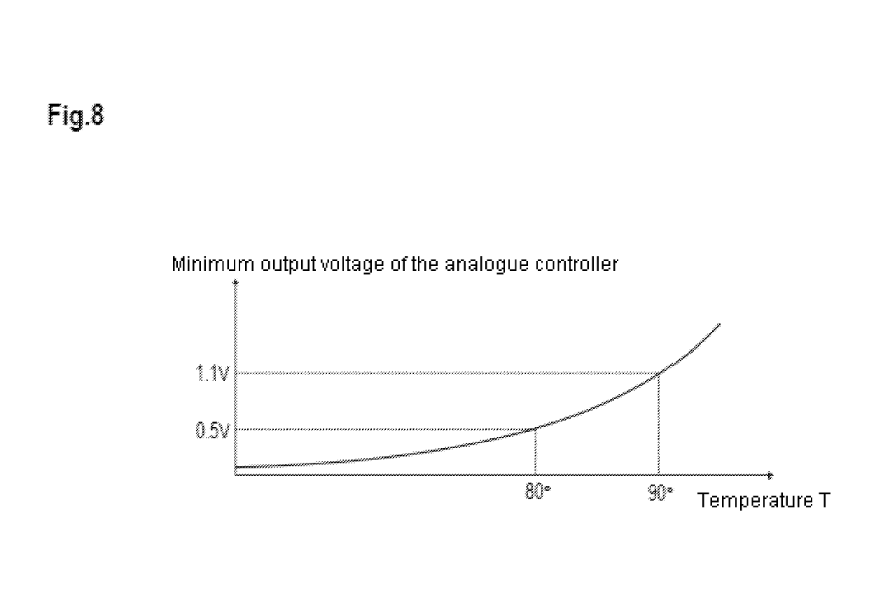

FIG. 8 shows an output voltage of the analog controller in dependence on the temperature T. According to the example stated above, the output voltage can be below 0.5 V only up to 80° C. Above 80° C., the temperature-dependent voltage limiter specifies a lower threshold value of greater than 0.5 V for the output voltage of the analog controller and thus limits the maximum possible lamp power.

Instead of the temperature-dependent voltage limiter, a temperature-dependent voltage can also be added to the output voltage of the operational amplifier 304. This temperature-dependent voltage can be compensated by the operational amplifier as long as its output voltage is greater than 0 V. If the output voltage of the operational amplifier becomes 0 V, the added temperature-dependent voltage acts like the limiter described above.

### LIST OF REFERENCE DESIGNATIONS

101 Lamp
   102 Operational amplifier (analog controller)
103 Voltage-controlled oscillator (VCO)
104 Logic circuit
105 Current source (provides fault current I_{F})
106 Setpoint value
107 Fault signal
108 Node
109 Node
201 Frequency counter
202 Switching unit
203 Digital processing unit (PU controller)
204 Analog/digital converter
205 Logic circuit
206 Fault signal
   207 Setpoint value
   208 Output of the logic circuit 205 (specifies if fault mode or normal mode is present)
209 Output of the logic circuit 205 (operating frequency)
210 Analog/digital converter
301 Frequency counter
302 Switching unit
303 Analog/digital converter
304 Operational amplifier (analog controller)
305 Logic circuit
306 Fault signal
307 Setpoint value
308 Output of the logic circuit 305 (specifies if fault mode or normal mode is present)
309 Output of the logic circuit 305 (operating frequency)
401 Time interval, normal mode
402 Time interval, fault mode
403 Time interval, normal mode
501 Logic circuit
502 Digital/analog converter
503 Output of the logic circuit (sets operational amplifier)
601 Preheating mode
602 Igniting mode
603 Normal mode
604 Variation of the operating frequency, the associated analog output signal of which is set at the operational amplifier 304
605 Variation of the operating frequency which is set by the logic circuit
606 Variation of the operating frequency which is set by the operational amplifier
701 Temperature-dependent voltage limiter
D1 Diode
S1 (electronic) switch (e.g. transistor, Mosfet, or similar)
Q1 Mosfet
Q2 Mosfet
Q3 pnp transistor
L1 Inductance (coil)
V_{Bus} Supply voltage for bridge circuit
R1, R2, R4, R5, R6, R7: Resistors
C1-C8 Capacitors

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A circuit for driving a lamp, which is operated via a bridge circuit, the circuit comprising:
an analog controller configured to drive the bridge circuit in a first operating mode; and
a logic circuit configured to drive the bridge circuit in a second operating mode.

2. The circuit as claimed in claim 1,
wherein the lamp is a fluorescent lamp.

3. The circuit as claimed in claim 1,
wherein the first operating mode is a normal mode in which the lamp is alight and neither too high an output voltage of the circuit nor too high a current occurs in the bridge circuit.

4. The circuit as claimed in claim 1,
wherein the second operating mode is a fault mode.

5. The circuit as claimed in claim 4,
wherein the fault mode comprises at least one of a preheating mode and an igniting mode.

6. The circuit as claimed in claim 1,
wherein the fault mode comprises a state in which the lamp is alight,

7. The circuit as claimed in claim 6,
wherein in the state in which the lamp is alight, the circuit is configured such that at least one of the following is achieved:
the circuit exhibits an output voltage which is greater than a predetermined voltage threshold value and
a current which is greater than a predetermined current threshold value flows in the bridge circuit.

8. The circuit as claimed in claim 1, further comprising:
a bridge circuit coupled to the analog controller and to the logic circuit.

9. The circuit as claimed in claim 8,
wherein the bridge circuit exhibits a half-bridge circuit with two electronic switches the center tap of which is connected to the lamp via an inductance.

10. The circuit as claimed in claim 1,
wherein the bridge circuit can be driven via a frequency counter,
wherein the analog controller is connected to the frequency counter via an analog/digital converter in the first operating mode.

11. The circuit as claimed in claim 1,
wherein the logic circuit initiates the switchover between the first operating mode and the second operating mode via a control signal.

12. The circuit as claimed in claim 1,
wherein the analog controller comprises an operational amplifier, the inverting input of which is connected to a setpoint value, the inverting input of which is connected via a capacitor to the output and at the non-inverting input of which an actual value of a lamp power or of a lamp current can be determined.

13. The circuit as claimed in claim 1,
wherein, as long as the lamp is not alight, the analog controller is set in such a manner that an output signal provided by it for driving the bridge circuit corresponds to a frequency which is between the operating frequency during the preheating and the operating frequency on igniting.

14. The circuit as claimed in claim 13,
wherein the output signal of the analog controller corresponds to a mean value of the voltage for the current operating frequency f and a voltage for a preheating frequency fₘₐₓ.

15. The circuit as claimed in claim 1,
wherein a minimum operating frequency can be limited with rising temperature.

16. The circuit as claimed in claim 1,
wherein in which a temperature-dependent voltage limiter is provided by means of which a lower threshold value of a signal provided by the analog controller can be limited in dependence on the temperature.

17. A lamp, comprising:
a circuit for driving a lamp, which is operated via a bridge circuit, the circuit comprising:
an analog controller configured to drive the bridge circuit in a first operating mode; and
a logic circuit configured to drive the bridge circuit in a second operating mode.

18. A light fixture, comprising:
a circuit for driving a lamp, which is operated via a bridge circuit, the circuit comprising:
an analog controller configured to drive the bridge circuit in a first operating mode; and
a logic circuit configured to drive the bridge circuit in a second operating mode.

19. A luminous module, comprising:
a circuit for driving a lamp, which is operated via a bridge circuit, the circuit comprising:
an analog controller configured to drive the bridge circuit in a first operating mode; and
a logic circuit configured to drive the bridge circuit in a second operating mode.

20. A method for driving a lamp, which is operated via a bridge circuit, the method comprising:
driving the bridge circuit via an analog controller in a first operating mode; and
driving the bridge circuit via a logic circuit in a second operating mode.
